(19) United States
(12) Patent Application Publication
(10) Pub. No.: US 2026/0161357 A1
(43) Pub. Date: Jun. 11, 2026

(54) Systems And Methods For Area Efficient Multi-Precision Dot Product Determination

(71) Applicant: SambaNova Systems, Inc., Palo Alto, CA (US)

(72) Inventor: Jeffrey S. Brooks, Austin, TX (US)

(73) Assignee: SambaNova Systems, Inc., Palo Alto, CA (US)

(21) Appl. No.: 18/974,772

(22) Filed: Dec. 9, 2024

(51) Int. Cl. G06F 7/544; G06F 7/483

(52) U.S. Cl. CPC G06F 7/5443; G06F 7/483

(57) ABSTRACT

A system for area efficient multi-precision dot product determination is disclosed. Input wires may receive 16-bit operands that include BF16 operands and may receive 8-bit operands that include FP8 operands. Multiplier circuitry may produce brain float (BF) products in response to receiving the BF16 operands and may produce floating point (FP) products in response to receiving the FP8 operands. A product converter may produce aligned products in response to receiving the BF products and in response to receiving the FP products. An adder may produce a floating sum in response to receiving the aligned products. A floating sum converter may produce a normalized sum in response to receiving the floating sum. An accumulator may produce an accumulated sum in response to receiving the normalized sum. Sixteen of the input wires may receive one of the 16-bit operands and may receive two of the 8-bit operands.

### TECHNICAL FIELD

The systems and methods relate to vector processing, computing vector dot products, arithmetic logic units, pipelined data paths, and more specifically to computing dot products of vectors having operands in a variety of formats such as 16 bit brain float (BF16), 8 bit floating point (FP8), and 8 bit integer (INT8).

### BACKGROUND

Artificial intelligence (AI) workloads often require linear algebraic operations such as vector dot product calculations. Vector dot product calculations are needed for other calculations such as matrix multiplication. It is well known that general purpose central processing units (CPUs) are not ideal for such calculations. Special purpose circuitry has therefore been developed for carrying out linear algebraic algorithms. That circuitry may include circuits for carrying out single instruction multiple data (SIMD) operations, as is known in the art. For example, coarse-grained reconfigurable (CGR) architectures are being developed for implementing AI workloads. A CGR architecture may include one or more coarse grained reconfigurable processors (CGRP) that have circuitry tailored for SIMD operations. Advances in such specialized circuits are needed for more efficient use of the circuitry implementing AI workloads and more efficient use of the energy consumed by that circuitry while implementing AI workloads.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure as a prelude to the more detailed description that is presented later.

An aspect of the subject matter described in this disclosure may be implemented by a system. The system may include input wires configured to receive 16-bit operands that include BF16 operands and to receive 8-bit operands that include FP8 operands, multiplier circuitry configured to produce brain float (BF) products in response to receiving the BF16 operands and to produce floating point (FP) products in response to receiving the FP8 operands, a product converter configured to produce aligned products in response to receiving the BF products and in response to receiving the FP products, an adder configured to produce a floating sum in response to receiving the aligned products, a floating sum converter configured to produce a normalized sum in response to receiving the floating sum, and an accumulator configured to produce an accumulated sum in response to receiving the normalized sum, wherein sixteen of the input wires are configured to receive one of the 16-bit operands and to receive two of the 8-bit operands.

Another aspect of the subject matter described in this disclosure may be implemented in a method. The method may include producing, by a multiplier circuit and in parallel, a plurality of products in response to receiving a plurality of operands. The method may further include producing a plurality of aligned products in response to receiving the products, producing a floating sum in response to receiving the aligned products, producing a normalized sum in response to receiving the floating sum, and producing an accumulated sum in response to receiving the normalized sum, wherein the operands include BF16 operands and FP8 operands, the products include brain float (BF) products and floating point (FP) products, the multiplier circuit configured to produce the BF products in response to receiving the BF16 operands, and the multiplier circuit configured to produce the FP products in response to receiving the FP8 operands.

Yet another aspect of the subject matter described in this disclosure may be implemented by a system. The system may include input wires configured to receive a plurality of operands that include BF16 operands and FP8 operands, a multiplication means for producing a plurality of products in response to receiving the operands, an alignment means for producing a plurality of aligned products in response to receiving the products, a summation means for producing a floating sum in response to receiving the aligned products, a conversion means for producing a normalized sum in response to receiving the floating sum, an accumulation means for producing an accumulated sum in response to receiving the normalized sum, wherein the multiplication means for producing the products in response to receiving the operands is configured to produce the products in parallel, and the multiplication means for producing the products in response to receiving the operands is configured to produce brain float (BF) products in response to receiving the BF16 operands and to produce floating point (FP) products in response to receiving the FP8 operands.

In some implementations of the methods and devices, the FP8 operands are converted to BF16 before multiplication by the multiplier circuitry. In some implementations of the methods and devices, the 8-bit operands include INT8 operands, the multiplier circuitry is further configured to produce integer products in response to receiving the INT8 operands, the adder is further configured to produce an integer sum in response to receiving the integer products, and the accumulator is further configured to produce the accumulated sum in response to receiving the integer sum. In some implementations of the methods and devices, the multiplier circuitry, the product converter, the adder, and the floating sum converter are configured to produce results each clock cycle. In some implementations of the methods and devices, the accumulator is configured to accumulate a plurality of normalized sums and a plurality of integer sums into a plurality of intermediate results, the accumulator is configured to accumulate the normalized sum and the integer sum into one of the intermediate results, and summing the intermediate results produces the accumulated sum. In some implementations of the methods and devices, the multiplier circuitry includes eight multipliers that are each configured to produce one of the FP products in response to receiving two of the FP8 operands, and to produce one of the integer products in response to receiving two of the INT8 operands, and four of the eight multipliers are each further configured to produce one of the BF products in response to receiving two of the BF16 operands.

In some implementations of the methods and devices, the aligned products have a two's complement 33-bit mantissa. In some implementations of the methods and devices, the floating sum has a mantissa that is sign-magnitude. In some implementations of the methods and devices, the floating sum has a 33-bit sign-magnitude mantissa and the normalized sum has a 25-bit sign-magnitude mantissa. In some implementations of the methods and devices, the normalized sum has a 25-bit mantissa, an 8-bit exponent, and a 1-bit sign. In some implementations of the methods and devices, an intermediate format has a 25-bit mantissa, an 8-bit exponent, and a 1-bit sign, the floating sum converter is configured to produce a plurality of normalized sums having the intermediate format, and the accumulator is configured to accumulate the normalized sums into a plurality of intermediate results having the intermediate format. In some implementations of the methods and devices, the system further includes an intra stage register block configured to store the accumulated sum as an unrounded value in a pattern compute unit (PCU) internal format, and a tail configured to convert the unrounded value stored in the intra stage register block to a rounded value in an externally supported format, wherein the tail is configured to store the rounded value in a PCU output register block.

In some implementations of the methods and devices, at least one of the FP8 operands is converted to BF16 before multiplication by the multiplier circuit. In some implementations of the methods and devices, the method further includes producing, by the multiplier circuit, a plurality of integer products in response to receiving a plurality of INT8 operands, producing an integer sum in response to receiving the integer products, wherein an adder is configured to produce the floating sum and to produce the integer sum, and an accumulator is configured to produce the accumulated sum in response to receiving the normalized sum and to produce the accumulated sum in response to receiving the integer sum. In some implementations of the methods and devices, a product converter is configured to produce the aligned products, the multiplier circuit, the product converter, and the adder, are configured to produce results in a single clock cycle, and the accumulator is configured to require a plurality of clock cycles to add the floating sum to an intermediate result stored in a register of the accumulator. In some implementations of the methods and devices, the accumulator is configured to accumulate a plurality of normalized sums and a plurality of integer sums into a plurality of intermediate results, the accumulator is configured to accumulate the normalized sum and the integer sum into one of the intermediate results, and summing the intermediate results produces the accumulated sum. In some implementations of the methods and devices, the multiplier circuit includes eight multipliers that are each configured to produce one of the FP products in response to receiving two of the FP8 operands, and to produce one of the integer products in response to receiving two of the INT8 operands, and four of the eight multipliers are each configured to produce one of the BF products in response to receiving two of the BF16 operands.

In some implementations of the methods and devices, the plurality of operands further include INT8 operands, the multiplication means is configured to produce integer products in response to receiving the INT8 operands, the summation means is configured to produce an integer sum in response to receiving the integer products, and the accumulation means is configured to produce the accumulated sum in response to receiving the integer sum.

These and other aspects will become more fully understood upon a review of the detailed description, which follows. Other aspects and features will become apparent to those of ordinary skill in the art, upon reviewing the following description of specific examples in conjunction with the accompanying figures. While features may be discussed relative to certain examples and figures below, any example may include one or more of the advantageous features discussed herein. In other words, while one or more examples may be discussed as having certain advantageous features, one or more of such features may also be used in accordance with the various examples discussed herein. In similar fashion, while the examples may be discussed below as devices, systems, or methods, the examples may be implemented in various devices, systems, and methods.

### BRIEF DESCRIPTION OF THE DRAWINGS

FIG. 1 is a block diagram illustrating an example of a coarse-grained reconfigurable (CGR) architecture system that may include circuitry for area efficient multi-precision dot product determination, according to some aspects.

FIG. 2 is a simplified block diagram illustrating an example of a CGR processor (CGRP) having a CGR array (CGRA), according to some aspects.

FIG. 3 is a simplified block diagram illustrating an example of a CGR array of an CGRP, according to some aspects.

FIG. 4 is a functional block diagram illustrating an example of a pattern compute unit (PCU), according to some aspects.

FIG. 5 is a high level block diagram illustrating an example of circuitry for area efficient multi-precision dot product determination, according to some aspects.

FIG. 6 is a high level block diagram illustrating an example of the circuitry illustrated in FIG. 5 configured to produce a floating sum from 16-bit brain float (BF16) operands, according to some aspects.

FIG. 7 is a high level block diagram illustrating an example of the circuitry illustrated in FIG. 5 configured to produce a floating sum from 8-bit floating point (FP8) operands, according to some aspects.

FIG. 8 is a high level block diagram illustrating an example of the circuitry illustrated in FIG. 5 configured to produce an integer sum from 8-bit integer (INT8) operands, according to some aspects.

FIG. 9A is an illustration of an example of the circuitry illustrated in FIG. 5 configured to produce accumulated results by accumulating floating sums, according to some aspects.

FIG. 9B is an illustration of an example of an intra stage register block passing values to a subsequent SIMD stage, according to some aspects.

FIG. 9C is an illustration of an example of an intra stage register block passing unrounded values to a tail configured to convert unrounded values to rounded values, according to some aspects.

FIG. 10 is an illustration of an example of the circuitry illustrated in FIG. 5 configured to produce accumulated results by accumulating integer sums, according to some aspects.

FIG. 11 is a high-level flow diagram illustrating an example of a method for multi-precision dot product determination, according to some aspects.

FIG. 12 illustrates an example of a computer, including an input device, a processor, a storage device, and an output device, according to some aspects.

Throughout the description, similar reference numbers may be used to identify similar elements.

### DETAILED DESCRIPTION

It will be readily understood that the components of the examples as generally described herein and illustrated in the appended figures could be arranged and designed in a wide variety of different configurations. Thus, the following more detailed description of various examples, as represented in the figures, is not intended to limit the scope of the present disclosure but is merely representative of various examples. While the various aspects of the examples are presented in drawings, the drawings are not necessarily drawn to scale unless specifically indicated.

Systems and methods that implement aspects may have various differing forms. The described systems and methods are to be considered in all respects only as illustrative and not restrictive. The scope of the claims is, therefore, indicated by the claims themselves rather than by this detailed description. All changes which come within the meaning and range of equivalency of the claims are to be embraced within their scope.

Reference throughout this specification to features, advantages, or similar language does not imply that any system or method implements each and every aspect that may be realized. Rather, language referring to the features and advantages is understood to mean that a specific feature, advantage, or characteristic described in an example may be implemented in or by at least one example. Thus, discussions of the features and advantages, and similar language, throughout this specification may, but do not necessarily, refer to the same example.

Furthermore, the described features, advantages, characteristics, and aspects may be combined in any suitable manner in one or more systems or methods. One skilled in the relevant art will recognize, in light of the description herein, that one example may be practiced without one or more of the specific features or advantages of another example. In other instances, additional features and advantages may be recognized in one example that may not be present in all the examples.

Reference throughout this specification to “one example”, “an example”, or similar language means that a particular feature, structure, or characteristic described in connection with the indicated example is included in at least one example. Thus, the phrases “in one example”, “in an example”, and similar language throughout this specification may, but do not necessarily, all refer to the same example.

Current and contemplated AI workloads require specialized circuitry for the efficient performance of linear algebraic calculations such as calculating the dot product of two vectors because dot product calculation is an aspect of larger calculations such as multiplying two tensors. Area efficient circuits are crucial for AI workloads for numerous reasons. A circuit requiring less area in a chip may be more efficient because silicon die area directly correlates with manufacturing costs, likelihood of defects, and power consumption. A circuit requiring less area in a chip may be more efficient because shorter distances between components may reduce signal propagation delays, allow higher clock frequencies, and allow fitting more units within a chip. Furthermore, area efficient compute units may be placed closer to memory blocks. Area efficient circuits for calculating dot products are therefore advantageous for many workloads, including AI workloads.

CGRPs may include circuitry for area efficient and fast dot product calculations. The circuitry may include a series of processing stages. The initial stages may perform parallel multiply operations on chunks of the input vectors, sum the products, and pass that sum to an accumulator. For example, the dot product of two 8192 element vectors requires 8192 multiplications resulting in 8192 products that are added together to produce the dot product. The multiplication stage, consisting of multiplier circuitry, may perform eight of those multiplications per clock cycle and a subsequent adder stage may add the eight products together to produce a sum. As such, the 8192 multiplications may be performed in 1024 clock cycles, resulting in a sequence of 1024 sums (one per clock cycle after the first multiplication products are received). Those sums can be added together by an accumulator that produces one or more accumulated results. As such, only one accumulator is required, therefore requiring less area on the chip than previous circuits. For example, a previous circuit requires an accumulator for each of the products produced by the multiplier stage. Such a circuit would require eight accumulators if eight products are produced per clock cycle. That previous circuit may require eight times more chip area for accumulators when compared to the circuit requiring only a single accumulator.

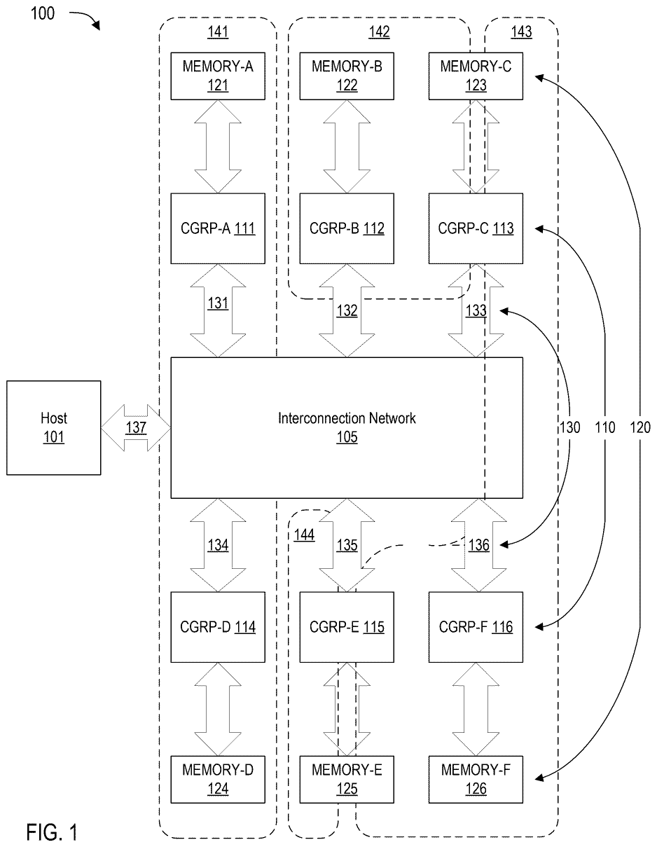

FIG. 1 is a block diagram illustrating an example of a coarse-grained reconfigurable (CGR) architecture system 100 that may include circuitry for area efficient multi-precision dot product determination, according to some aspects. As illustrated, the CGR architecture system 100 includes a host 101, a number of coarse grained reconfigurable processors (CGRPs) 110 (111-116), an interconnection network 105 and communication links 130 (131-137) that connect the host 101 and the CGRPs 110 to the interconnection network 105. Host 101 may be a general purpose computer that runs runtime processes and computer programs such as a compiler. The compiler may compile an AI algorithm to produce code, configuration data, and execution graphs for running the AI algorithm on the CGR architecture system 100. The CGR architecture system 100 may also include memories 120 respectively coupled to the CGRPs 110 including memory-A 121 coupled to CGRP-A 111, memory-B 122 coupled to CGRP-B 112, memory-C 123 coupled to CGRP-C 113, memory-D 124 coupled to CGRP-D 114, memory-E 125 coupled to CGRP-E 115, and memory-F 126 coupled to CGRP-F 116. The memories 120 can be any type of memory, including dynamic data rate (DDR) dynamic random-access memory (DRAM), high-bandwidth memory (HBM), static memory, or flash memory.

The communication links 130 can be any type of communication link, parallel or serial, electrical or optical, but in some implementations, each may be one or more physical Ethernet links. The Ethernet links may be compliant with any version of the Ethernet specification. The interconnection network 105 may have any type of topology depending on the system design. In some implementations, the interconnection network 105 may be implemented as direct links between pairs of devices where each device is one of CGRP 111-116 or host 101. For example, the host may have 6 individual links that respectively directly connect to the 6 CGRPs 111-116 and each CGRP may, in addition to its link connecting to the host 101, have a link to each of the other CGRPs 111-116. In that implementation, CGRP-A 111 has a first link connecting directly to the host 101, a second link connecting directly to CGRP-B 112, a third link connecting directly to CGRP-C 113, a fourth link connecting directly to CGRP-D 114, a fifth link connecting directly to CGRP-E 115, and a sixth link connecting directly to CGRP-F 116; so link 131 may include 6 individual links. In other examples, the interconnection network 120 may include a bus structure, a switching fabric, or one or more switches and/or routers that are able to route a transaction from an originating CGRP 110 or host 101 to a destination CGRP 110 or host 101.

Each of the CGRPs 110 may include a grid of compute units and memory units interconnected with an internal switching array fabric such as those detailed elsewhere in this specification. The CGRPs 110 may be configured by downloading configuration data from the host 101 to configure the CGRPs 110 to execute one or more graphs (e.g., execution graphs 141-144) that define dataflow computations, and can implement any type of functionality including, but not limited to neural networks. The communication links 130 and the interconnection network 105 provide a high degree of connectivity that can increase the dataflow bandwidth between the CGRPs 110 and enable the CGRPs 110 to cooperatively process large volumes of data via the dataflow operations specified in the execution graphs 141-144.

A set of execution graphs 141-144 can be assigned to the CGR architecture system 100 for execution. The graphs 141-144 are overlaid on the block diagram of the CGR architecture system 100 showing how they may be assigned to the CGRPs 110. In the example shown, graph1 141 is assigned to CGRP-A 111 and CGRP-D 114, graph2 142 is assigned to CGRP-B 112 and sections of CGRP-C 113, graph3 143 is assigned to sections of CGRP-C 113, CGRP-F 116, and sections of CGRP-E 115, while graph4 144 is assigned to sections of CGRP-E 115. While the set of graphs 141-144 is statically depicted, one of skill in the art will appreciate that the execution graphs are likely not synchronous (i.e., of the same duration) and that the partitioning within a CGR computing environment will likely be dynamic as execution graphs are completed and replaced.

As can be understood from FIG. 1, nodes of a graph may be distributed across multiple CGRPs. Nodes of a graph within a CGRP may communicate using internal communication paths of the CGRP, but communication between nodes of a single graph in different CGRPs may use Ethernet direct memory access (E-DMA) or peer-to-peer (P2P) communication over the links 130 and interconnection network 105.

FIG. 1 shows example graph1 141 spread across multiple CGRPs with CGRP-A 111 configured to execute a first node of the graph1 141, and another CGRP-D 114 configured to execute a second node of the same graph1 141. The first node of graph1 141 may send data to the second node of graph1 141. For the purposes of this disclosure, in a typical system, a connected processor of host 101 may be used to move the data from the first node to the second node. In contrast, a CGR architecture system may allow CGRP-A 111 to send the data from the first node directly to CGRP-D 114 without passing through the host 101.

As mentioned above, the host 101 may configure the CGRPs 110 by downloading configuration files to the CGRPs 110. This may be accomplished by sending the configuration files over the communication links 130 and interconnection network 105. The configuration files can include information to configure individual units within the CGRPs 110 as well as the internal communication paths between those units. The configuration files may be static for the duration of execution of a graph and may configure a portion of one of CGRPs 111-116 (or the entire CGRP) to execute one or more nodes of an execution graph 141-144.

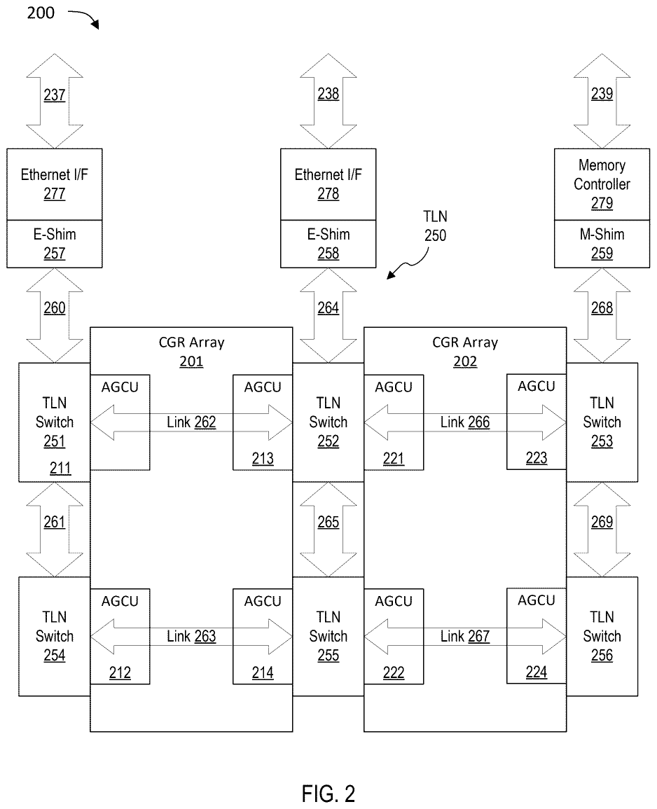

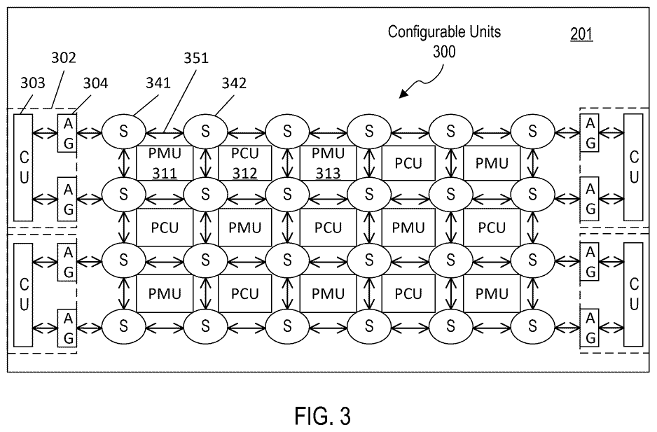

FIG. 2 is a simplified block diagram illustrating an example of a coarse grained reconfigurable processor (CGRP) having a CGR array (CGRA), according to some aspects. CGRP 200 may be used as CGRP 111-116 in the CGR architecture system 100 of FIG. 1. In this example, the CGRP 200 has 2 CGR arrays (CGR array 201, CGR array 202), although other implementations can have any number of CGR arrays, including a single CGR array. Each CGR array 201, 202 (which is shown in more detail in FIG. 3) comprises an array of configurable units connected by an array-level network (ALN) in this example. Each of the two CGR arrays 201 and 202 has one or more address generation and coalescing units (AGCUs) 211-214, 221-224. The AGCUs are nodes on both a top-level network (TLN) 250 and on ALNs within their respective CGR arrays 201, 202 and include resources for routing data among nodes on the TLN 250 and nodes on the ALN in each CGR array 201, 202.

The CGR arrays 201-202 are coupled to TLN 250 that includes TLN switches 251-256 and links 260-269 that allow for communication between elements of CGR array 201, elements of CGR array 202, and shims to other functions of the CGRP 200 including Ethernet shims (E-Shims) 257, 258 and a memory shim (M-Shim) 259. The M-Shim 259 can support any type of memory including dynamic data rate (DDR) dynamic random-access memory (DRAM), high-bandwidth memory (HBM), static memory, or flash memory.

Other functions of the CGRP 200 may connect to the TLN 250 in different implementations, such as additional shims to additional and or different input/output (I/O) interfaces and memory controllers, and other chip logic such as control/status registers (CSRs), configuration controllers, or other functions. Data travel in packets between the devices (including TLN switches 251-256) on the links 260-269 of the TLN 250. For example, TLN switches 251 and 252 are connected by a link 262, TLN switches 251 and E-Shim 257 are connected by a link 260, TLN switches 251 and 254 are connected by a link 261, and TLN switch 253 and M-Shim 259 are connected by a link 268.

E-Shims 257, 258 provide an interface between the TLN 250 and Ethernet Interfaces 277, 278 which connect to external communication links 237, 238 which may form part of communication links 130 as shown in FIG. 1. While two E-Shims 257, 258 with Ethernet interfaces 277, 278 and associated Ethernet links 237, 238 are shown, implementations may have any number of E-Shims and associated Ethernet interfaces and links. A M-Shim 259 provides an interface to a memory controller 279, which has a memory interface 239 and may connect to memory such as the memory 120 of FIG. 1. While only one M-Shim 259 is shown, implementations may have any number of M-Shims and associated memory controllers and memory interfaces. Different implementations may include memory controllers for varied types of memory, such as a DDR DRAM memory controller, a flash memory controller, a static memory controller, and/or a high-bandwidth memory (HBM) controller. The interfaces 257-259 include resources for routing data among nodes on the top-level network (TLN) 250 and external devices, such as high-capacity memory, host processors, other CGRPs, FPGA devices and so on, that are connected to the interfaces 257-259 through external links 237-239.

Each CGRP may include an array of configurable units that is disposed in a configurable interconnect (ALN), and the configuration data may define a dataflow graph including functions in the configurable units and links between the functions in the configurable interconnect. In this manner, the configurable units function as sources or sinks of data used by other configurable units providing functional nodes of the graph. Such systems can use external data processing resources not implemented using the configurable array and interconnect, including memory and a processor executing a runtime program, as sources or sinks of data used in the graph.

FIG. 3 is a simplified block diagram illustrating an example of a CGR array of an CGRP, according to some aspects. CGR array 201 may be identical to CGR array 202 of FIG. 2. The configurable units 300 in the CGR array 201 are nodes on the array-level network. In this example, the configurable units 300 include a plurality of types of configurable units. The types of configurable units in this example include Pattern Compute Units (PCU) such as PCU 312, Pattern Memory Units (PMU) such as PMUs 311, 313, switch units(S) such as Switches 341, 342, and Address Generation and Coalescing Units (AGCU) such as AGCU 302. An AGCU can include one or more address generators (AG) such as AG 304 and a shared coalescing unit (CU) such as CU 303. Other implementations may include other types of configurable units such as other types of compute units, other types of memory units, and/or fused compute and memory units (FCMUs). For an example of the functions of these types of configurable units, see, Prabhakar et al., “Plasticine: A Reconfigurable Architecture for Parallel Patterns”, ISCA '17, Jun. 24-28, 2017, Toronto, ON, Canada.

Each of these configurable units contains a configuration store comprising a set of registers or flip-flops that represent either the setup or the sequence to run a program, and can include the number of nested loops, the limits of each loop iterator, the instructions to be executed for each stage, the source of the operands, and the network parameters for the input and output interfaces. Additionally, each of these configurable units contains a configuration store comprising a set of registers or flip-flops that store status usable to track progress in nested loops or otherwise. A configuration file contains data representing the initial configuration, or starting state, of each of the components that execute the program. Program load is the process of setting up the configuration stores in the array of configurable units by a configuration load/unload controller in an AGCU 302 based on the contents of the configuration file to allow all the components to execute a program (i.e., a graph). Program Load may also load data into a PMU memory.

The array-level network includes links that may interconnect the configurable units 300 in the CGR array 201. The links in the array-level network include one or more and, in this case three kinds of physical buses: a chunk-level vector bus (e.g., 128 bits of data), a word-level scalar bus (e.g., 32 bits of data), and a multiple bit-level control bus. In an example, interconnect 351 between switches 341 and 342 includes a vector bus interconnect with vector bus width of 128 bits, a scalar bus interconnect with a scalar bus width of 32 bits, and a control bus interconnect.

The three kinds of physical buses may differ in the granularity of data being transferred. In one example, the vector bus can carry a chunk that includes 16-Bytes (=128 bits) of data as its payload. The scalar bus can have a 32-bit payload and carry scalar operands or control information. The control bus can carry control handshakes such as tokens and other signals. The vector and scalar buses can be packet switched, including headers that indicate a destination of each packet and other information such as sequence numbers that can be used to reassemble a file when the packets are received out of order. Each packet header can contain a destination identifier that identifies the geographical coordinates of the destination switch unit (e.g. the row and column in the array), and an interface identifier that identifies the interface on the destination switch (e.g. North, South, East, West, etc.) used to reach the destination unit. The control network can be circuit switched based on timing circuits in the device, for example. The header is transmitted on a header bus to each configurable unit in the array of configurable units.

In one example, a chunk of data of 128 bits is transmitted on the vector bus that provides the chunk as vector inputs to a configurable unit. The vector bus can include 128 payload lines, and a set of header lines. The header can include a sequence ID for each chunk, which can include (as non-limiting examples): a bit to indicate if the chunk is scratchpad memory or configuration store data; bits that form a chunk number; bits that indicate a column identifier; bits that indicate a row identifier; and bits that indicate a component identifier.

The array-level network may route the data of the vector bus and/or scalar bus using two-dimension order routing using either a horizontal first or vertical first routing strategy. The vector bus and/or scalar bus may allow for other types of routing strategies, including using routing tables in switches to provide a more flexible routing strategy in some implementations. During execution of a machine after configuration, data can be sent via one or more-unit switches and one or more links between the unit switches to the configurable units using the vector bus and vector interface(s) of the one or more switch units on the array-level network.

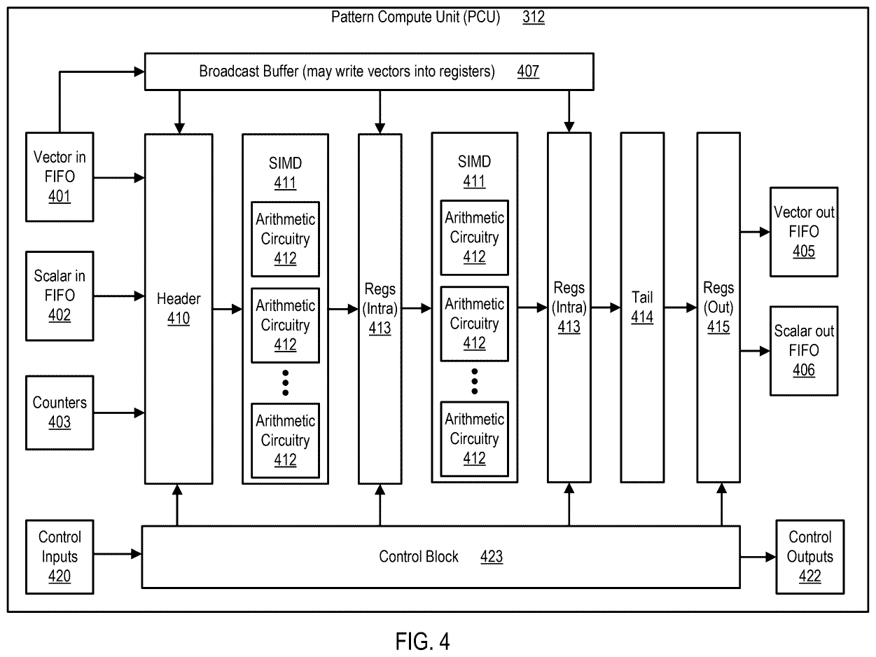

FIG. 4 is a functional block diagram illustrating an example of a pattern compute unit (PCU) 312, according to some aspects. The PCU 312 has inputs such as a vector in first-in first-out buffer (FIFO) 401, a scalar in FIFO 402. Counters 403, and control inputs 420. The vector in FIFO 401 may buffer vectors that are to be processed by the PCU. The scalar in FIFO 402 may provide values that may be used in calculations performed by the PCU. The counters 403 may include counter values for loops and other purposes. The control inputs 420 may be passed to control block 423. The control block 423 may load control values into the header 410, intra stage register blocks 413, and PCU output register block 415. The control values may configure the SIMD stages 411 and tail 414 for performing specific operations. In an example, a SIMD stage 411 may be configured to calculate the vector dot product of two vectors of BF16 operands while the tail 414 is configured to perform FP32 rounding operations. The vector in FIFO 401 may provide vectors to the header 410 and the broadcast buffer 407. As such, the header 410 may include registers and logic that prepares the input data (e.g., vectors supplied via vector in FIFO 401) for processing by the SIMD stages 411. The broadcast buffer 407 may pass values, such as vector operands, to the header 410 and the intra stage register blocks 413. The SIMD stages 411 contain arithmetic circuitry 412 and may perform single instruction multiple data operations. Here, calculation of vector dot products by the arithmetic circuitry 412 is considered a SIMD operation. The intra stage register blocks 413 may store data that is being clocked out of one processing block and into another. The tail 414 is a processing block that may perform specialized operations on data that is about to exit the PCU 312. Such operations may include rounding operations (e.g., converting FP32 values to BF16 values). The output of the tail 414 may be stored in PCU output register block 415. The outputs of the PCU 312 may be vectors held in a vector out FIFO 405, scalars held in a scalar out FIFO 406, and control outputs 422.

An important aspect of the PCU is that the SIMD stages may produce unrounded values in a PCU internal format such as a 34-bit unrounded format having one sign bit, an 8-bit exponent, and a UINT25 sign-magnitude mantissa. The intra stage register blocks 413 may store unrounded values in the PCU internal format. The tail 414 may include rounders 906 that can convert values from the PCU internal format to externally supported formats such as FP32, BF16, etc. The PCU output register block 415 can store values in the externally supported formats. A reason for using a PCU internal format is that it preserves numerical precision while relaxing the need for rounding values within the SIMD stages 411 and the need for rounding values exiting the SIMD stages 411. The rounding operations have been moved to the tail 414. As such, the SIMD stages 411 may lack rounders such as FP32 rounders, resulting in SIMD stages 411 that may be considerably smaller than similar elements that include rounders such as FP32 rounders.

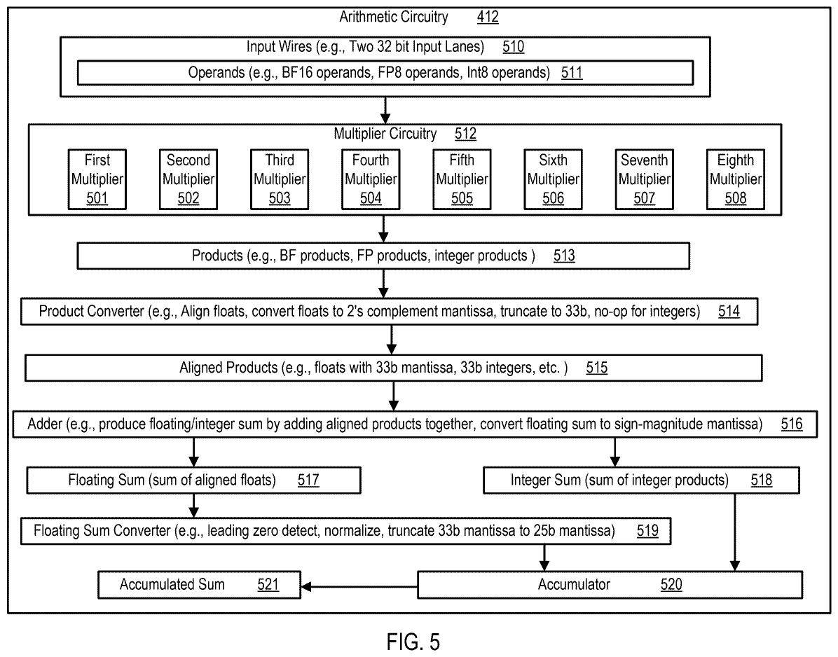

FIG. 5 is a high level block diagram illustrating an example of circuitry for area efficient multi-precision dot product determination, according to some aspects. The arithmetic circuitry 412 in a SIMD stage 411 of a PCU 312 may include circuitry for area efficient multi-precision dot product determination. As such, a PCU may include very many instances of circuitry for area efficient multi-precision dot product determination. The number of input wires 510 to the circuit may govern the number of operands processed per clock cycle because the input wires 510 carry a specific number of bits. For example, the input wires may carry 64-bits of vector A operands and 64-bits of vector B operands. If those operands are 16-bit operands, then there are four vector A operands and four vector B operands. If those operands are 8-bit operands, then there are eight vector A operands and eight vector B operands. The circuitry may therefore be configured to process a certain number of 16-bit operands per clock cycle and to process twice that number of 8-bit operands per clock cycle.

The circuitry for area efficient multi-precision dot product determination may include input wires 510, multiplier circuitry 512, a product converter 514, an adder 516, a floating sum converter 519, and an accumulator 520. The input wires 510 may carry operands 511 to the multiplier circuitry 512. The operands may be BF16 operands, FP8 operands, INT8 operands, or operands in some other format. BF16 is the well-known 16-bit “brain floating point” format specifically designed for AI and machine learning (ML) applications. BF16 has a 1-bit sign, 8-bit exponent, and 7-bits mantissa. Key aspects of BF16 include: same exponent size as FP32; similar dynamic range to FP32, lower precision than FP32, half the storage of FP32. FP32 is the 32-bit floating point format specified by the IEEE 754 standard and has 1-bit sign, 8-bits exponent, and 23-bits mantissa. FP8 refers to certain well-known 8-bit floating point formats primarily designed for AI and ML applications. The two main variants of FP8 are E4M3 (1-bit sign, 4-bit exponent, 3-bit mantissa) and E5M2 (1-bit sign, 5-bit exponent, 2-bit mantissa). INT8 (8-bit two's complement) is a fixed-point number format for integers that is commonly used in AI/ML inference.

The multiplier circuitry 512 includes a plurality of multipliers. The example shown in FIG. 5 has eight multipliers: a first multiplier 501; a second multiplier 502; a third multiplier 503; a fourth multiplier 504; a fifth multiplier 505; a sixth multiplier 506; a seventh multiplier 507; and an eighth multiplier 508. The multipliers produce products 513. For clarity of the examples, the products are BF products when the operands are BF16, are FP products when the operands are FP8, and are integer products when the operands are INT8. The products may be in different formats. For example, BF products may have 1-bit sign, 8-bits exponent, and 15-bits mantissa. FP products may be in the BF16 format, and integer products may be in the INT16 format (16-bit two's complement). Note that the FP products and the BF products may both have 1-bit sign and 8-bits exponent. Furthermore, note that an FP product may be converted to the same format as a BF product by zero padding the FP product's mantissa. As such, the same circuitry may be used for calculations involving BF products and involving FP products. When multiplying two floating point numbers, the exponent fields are added and the mantissas are multiplied. As such, the circuitry in the multipliers configured to multiply BF16 mantissas may also multiply INT8 operands.

The product converter 514 produces aligned products 515 in response to receiving the products 513. The product converter may adjust the BF products and the FP products such that they may be added together by the adder 516 in a single clock cycle. In some examples, the product converter 514 converts the products into aligned products in one clock cycle such that the adder adds the aligned products 515 together to produce a sum in the next clock cycle. In some implementations, the product converter is a “no-op” for integer products such that the integer products may also be the aligned products. The product converter may align the BF products and the FP products by detecting which product has the largest exponent and adjusting the other products to have the same exponent. For example, a product may be adjusted by increasing the exponent by 2 and shifting the mantissa by 2. The length of the mantissa may be increased (e.g., to 33-bits) to preserve precision. Furthermore, the mantissa may be converted to a two's complement format. As such, the aligned product may have an 8-bit exponent and a 33-bit mantissa when the products 513 are BF products or are FP products. Integer products may be converted from their current format (e.g., INT16) to a 33-bit two's complement format.

The adder 516 adds the aligned products together to produce a sum. If the aligned products are floating point, then the sum produced by the adder is a floating sum 517. The format of the floating sum 517 may have 1-bit sign, 8-bit exponent, and 33-bit mantissa. Note that the mantissa is now a sign-magnitude mantissa, not a two's complement mantissa. A sign-magnitude value such as a sign-magnitude mantissa has a sign bit and an unsigned integer indicating the magnitude. If the products 513 are in an integer format (e.g., INT16), then the sum is an integer sum 518 and may be in a 33-bit two's complement format. The floating sum converter 519 produces a normalized sum in response to receiving the floating sum 517. The normalized sum is passed to the accumulator 520. Integer sums may bypass the floating sum converter 519 and be passed directly to the accumulator 520. The accumulator may receive a sum every clock period because the multiplier circuitry, the product converter, the adder, and the floating sum converter are all configured to produce a result each clock cycle. The accumulator 520 accumulates the sums to produce an accumulated sum 521.

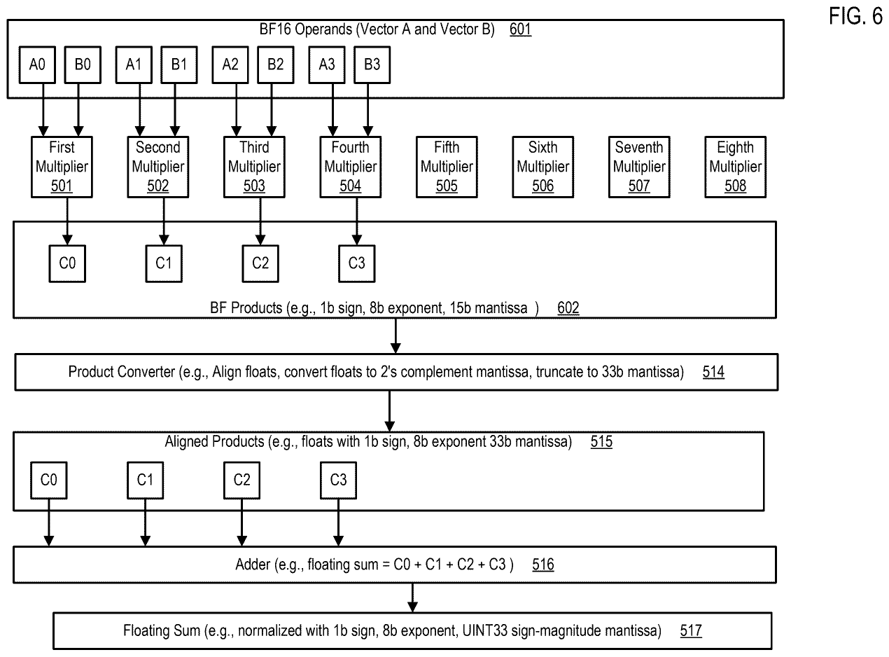

FIG. 6 is a high level block diagram illustrating an example of the circuitry illustrated in FIG. 5 configured to produce a floating sum from 16-bit brain float (BF16) operands 601, according to some aspects. The circuitry for area efficient multi-precision dot product determination shown in FIG. 5 is configured to operate on a certain number of input bits. For example, the input wires may carry 64-bits of vector A operands and 64-bits of vector B operands. BF16 has a 1-bit sign, 8-bits exponent, and 7-bits mantissa. If the operands are BF16 operands 601, then there are four vector A operands (A0, A1, A2, and A3) and four vector B operands (B0, B1, B2, and B3). The BF16 operands are passed to the multipliers. There are eight multipliers, as shown in FIG. 5, but only four of the multipliers are needed. As such, four of the multipliers produce BF products 602. The product of A0 and B0 is C0. The product of A1 and B1 is C1. The product of A2 and B2 is C2. The product of A3 and B3 is C3. The BF products may have 1-bit sign, 8-bits exponent, and 15-bit mantissa. The product converter 514 produces aligned products 515 in response to receiving the BF products by increasing the mantissa to 33-bits to preserve precision and prevent most significant bits and other bits from being shifted out of the mantissa during alignment. The product converter 514 aligns the products by adjusting them to have the same exponent. The product converter converts the mantissa to two's complement. The adder 516 produces a floating sum 517 in response to receiving the aligned products. In the example illustrated in FIG. 6, the floating sum may equal C0+C1+C2+C3.

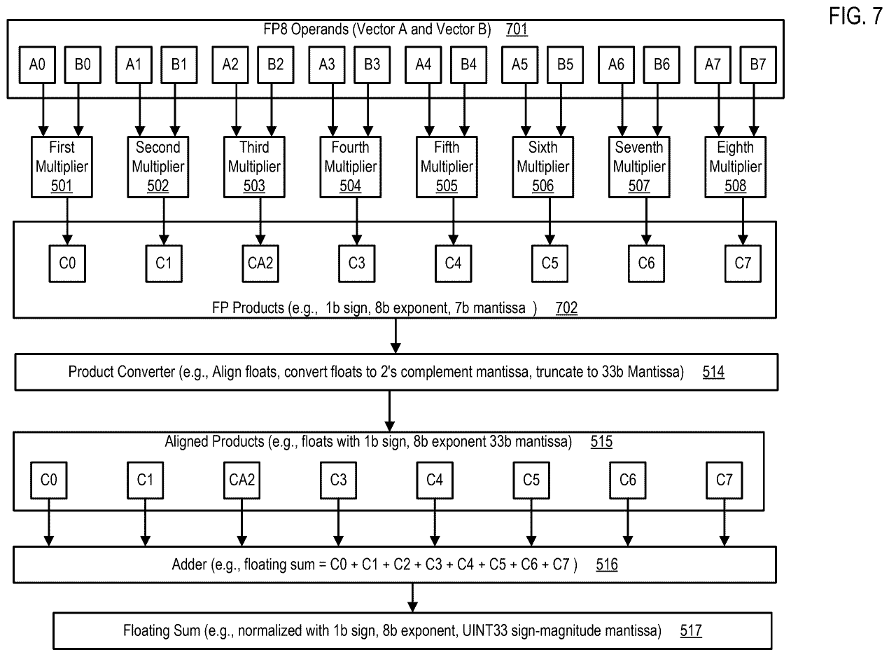

FIG. 7 is a high level block diagram illustrating an example of the circuitry illustrated in FIG. 5 configured to produce a floating sum from 8-bit floating point (FP8) operands 701, according to some aspects. The circuitry for area efficient multi-precision dot product determination shown in FIG. 5 is configured to operate on a certain number of input bits. For example, the input wires may carry 64-bits of vector A operands and 64-bits of vector B operands. FP8 values have 8-bits. If the operands are FP8 operands 701, then there are eight vector A operands (A0, A1, A2, A3, A4, A5, A6, and A7) and eight vector B operands (B0, B1, B2, B3, B4, B5, B6, and B7). The FP8 operands are passed to the multipliers. There are eight multipliers, as shown in FIG. 5, and all eight multipliers are needed. As such, the multipliers produce FP products 702. The product of A0 and B0 is C0. The product of A1 and B1 is C1. The product of A2 and B2 is C2. The product of A3 and B3 is C3. The product of A4 and B4 is C4. The product of A5 and B5 is C5. The product of A6 and B6 is C6. The product of A7 and B7 is C7. The FP8 products may be E4M3 having 1-bit sign, 4-bits exponent, and 3-bit mantissa or E5M2 having 1-bit sign, 5-bits exponent, and 2-bit mantissa. Note that four of the multipliers are also used for multiplying BF16 operands. As such, the FP8 operands passed to those multipliers, or to all the multipliers, may be converted to BF16 before the multiplication operations. The product converter 514 produces aligned products 515 in response to receiving the FP products by increasing the mantissa to 33-bits to preserve precision and prevent most significant bits and other bits from being shifted out of the mantissa during alignment. The product converter 514 aligns the products by adjusting them to have the same exponent. The product converter converts the mantissa to two's complement. The adder 516 produces a floating sum 517 in response to receiving the aligned products. In the example illustrated in FIG. 7, the floating sum may equal C0+C1+C2+C3+C4+C5+C6+C7.

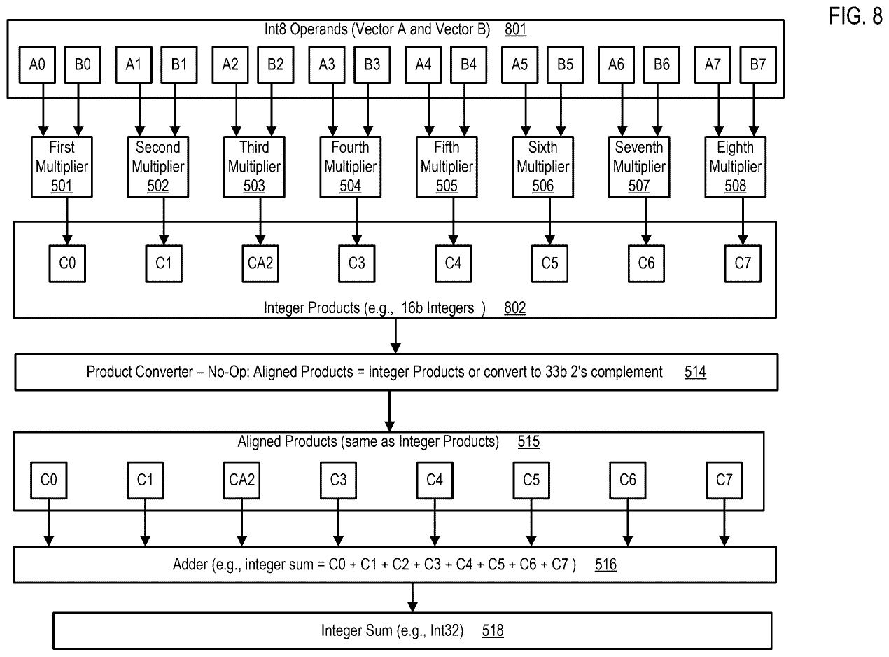

FIG. 8 is a high level block diagram illustrating an example of the circuitry illustrated in FIG. 5 configured to produce an integer sum from 8-bit integer (INT8) operands 801, according to some aspects. The circuitry for area efficient multi-precision dot product determination shown in FIG. 5 is configured to operate on a certain number of input bits. For example, the input wires may carry 64-bits of vector A operands and 64-bits of vector B operands. INT8 values have 8-bits. If the operands are INT8 operands 801, then there are eight vector A operands (A0, A1, A2, A3, A4, A5, A6, and A7) and eight vector B operands (B0, B1, B2, B3, B4, B5, B6, and B7). The INT8 operands are passed to the multipliers. There are eight multipliers, as shown in FIG. 5, and all eight multipliers are needed. As such, the multipliers produce integer products 802. The product of A0 and B0 is C0. The product of A1 and B1 is C1. The product of A2 and B2 is C2. The product of A3 and B3 is C3. The product of A4 and B4 is C4. The product of A5 and B5 is C5. The product of A6 and B6 is C6. The product of A7 and B7 is C7. The INT8 products may be INT16 (16-bit two's complement). The product converter 514 produces aligned products 515 in response to receiving the FP products, but these products are integer products. As such, the integer products may be passed directly to the adder 516 unchanged (but now called aligned products for consistency) or may be converted from 16-bit to 33-bit two's complement before being passed to the adder 516. The adder 516 produces an integer sum 518 in response to receiving the aligned products. In the example illustrated in FIG. 8, the integer sum may equal C0+C1+C2+C3+C4+C5+C6+C7.

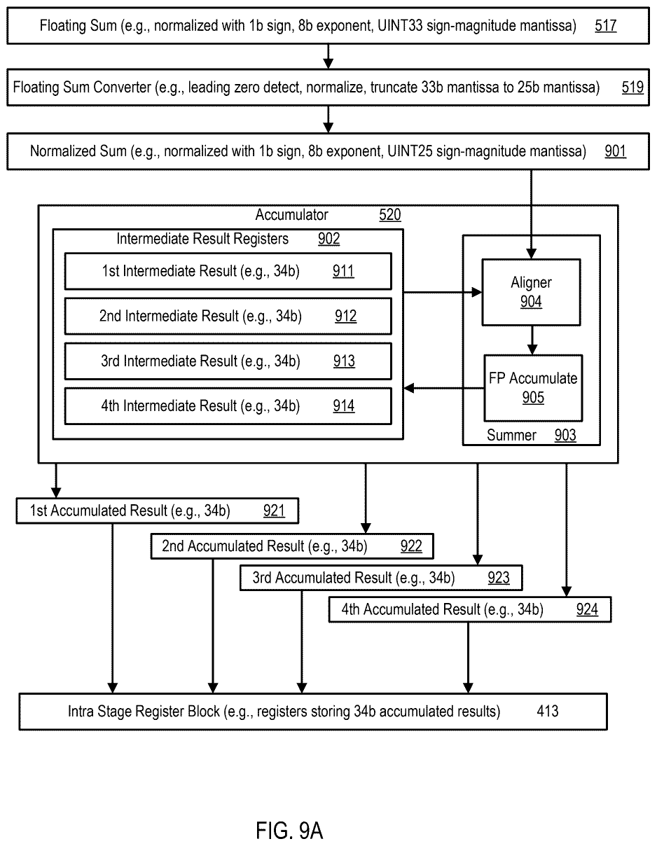

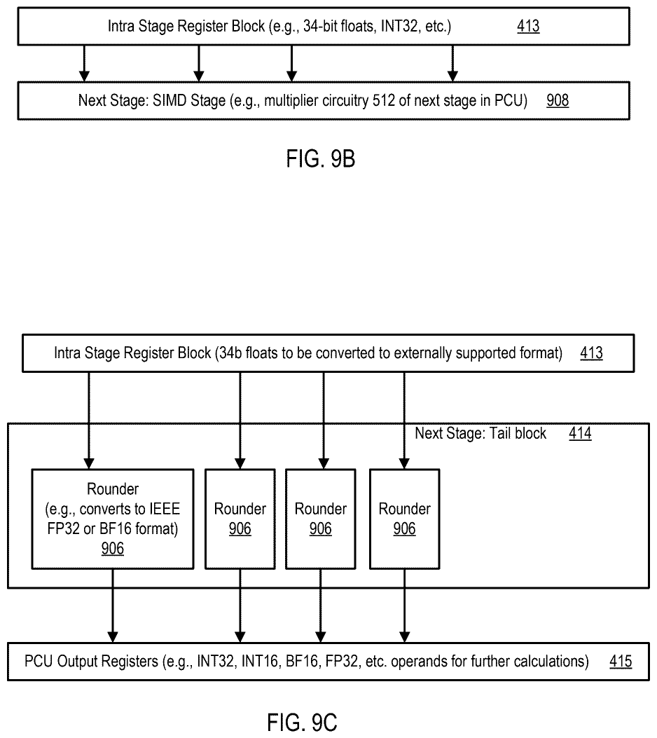

FIG. 9A is an illustration of an example of the circuitry illustrated in FIG. 5 configured to produce accumulated results by accumulating floating sums, according to some aspects. As shown in FIGS. 5, 6 and 7, the adder may produce floating sums 517. The floating sum converter 519 produces a normalized sum in response to receiving the floating sum 517. Floating point numbers may be normalized by adjusting the exponent and mantissa such that the “implicit” or “hidden” bit (which is one position to the left of the most significant mantissa bit) is a “1”. As such, the floating sum converter 519 may produce a normalized sum 901 by adjusting the floating sum 517 such that the “implicit” or “hidden” bit is a “1”. The floating sum converter 519 may then truncate the mantissa. For example, a 33-bit mantissa may be truncated to 25 bits.

The accumulator 520 may have intermediate result registers 902 and a summer 903. The illustrated example has four intermediate result registers storing a first intermediate result 911, a second intermediate result 912, a third intermediate result 913, and a fourth intermediate result 914. The summer 903 includes an aligner 904 and a floating point accumulate circuit 905. The aligner can receive a normalized sum and one of the intermediate results, align them within one clock cycle, and then pass the aligned values to the floating point accumulate circuit 905. The floating point accumulate circuit 905 can add the values in the next clock cycle, thereby accumulating the normalized sum into the intermediate result. The intermediate result (now including the normalized sum) may then be stored in the register it was obtained from. Here, the accumulator 520 requires two clock cycles for each normalized sum it receives but is receiving a normalized sum every clock cycle. As such, the accumulator cycles through the intermediate result registers. The illustrated accumulator may therefore receive a first, second, third, etc. normalized sum and may cycle through the intermediate result registers by accumulating the first, fifth, ninth, etc. normalized sums into the first intermediate result, by accumulating the second, sixth, tenth, etc. normalized sums into the second intermediate result, by accumulating the third, seventh, eleventh, etc. normalized sums into the third intermediate result, and by accumulating the fourth, eighth, twelfth, etc. normalized sums into the fourth intermediate result. The intermediate results may be read out of the accumulator as accumulated results. In an example, two large vectors are processed. When the last operands of the vectors have been processed, the first intermediate result 911 is read out as the first accumulated result 921, the second intermediate result 912 is read out as the second accumulated result 922, the third intermediate result 913 is read out as the third accumulated result 923, and the fourth intermediate result 914 is read out as the fourth accumulated result 924. The vector dot product of the two large vectors may be the first accumulated result 921 plus the second accumulated result 922 plus the third accumulated result 923 plus the fourth accumulated result 924.

It is common for accumulators to include rounders 906, to store intermediate results as rounded values, and to produce accumulated results as rounded values. Such accumulators often include FP32 rounders such that their intermediate results and accumulated results are in the FP32 format. As is known in the art, FP32 rounders implement rounding heuristics to preserve numerical precision. Accumulator 520 is different because there is no rounder in accumulator 520. Accumulator 520 is configured to use a PCU internal format (e.g., 1-bit sign, 8-bit exponent, and 25-bit mantissa). This PCU internal format preserves numerical precision within the accumulator without the use of a rounder, thereby simplifying the size and complexity of the accumulator. The PCUs are therefore smaller and simpler because there are a great many such accumulators in a PCU. For this reason, the example illustrated in FIG. 9A indicates that the normalized sums, the intermediate results, and the accumulated results are 34-bit unrounded values in the PCU internal format having 1-bit sign, 8-bit exponent, and 25-bit mantissa. The 34-bit unrounded numbers may be converted to an external format such as FP32 or BF16 at a later processing stage of the PCU (e.g., the tail block 414). Those familiar with arithmetic units and floating point formats are familiar with rounding circuitry that can reformat a floating point number having 1-bit sign, 8-bit exponent, and 25-bit mantissa to thereby produce a FP32 value, a BF16 value, or a FP16 value in response to receiving the floating point number having 1-bit sign, 8-bit exponent, and 25-bit mantissa.

FIG. 9B is an illustration of an example of an intra stage register block 413 passing values to a subsequent SIMD stage 908, according to some aspects. FIG. 9A shows an accumulator producing accumulated results that are stored in an intra stage register block 413. FIG. 4 shows a PCU that has numerous SIMD stages arranged in a pipeline that sequences results from one of the SIMD stages 411 to a subsequent one of the SIMD stages 411. FIG. 9B shows that the accumulated results produced in FIG. 9A may be stored in an intra stage register block 413 and then passed to the next SIMD stage 908 in the PCU. The accumulated results stored in the intra stage register block may be 34-bit unrounded values.

FIG. 9C is an illustration of an example of an intra stage register block 413 passing unrounded values to a tail block 414 configured to convert unrounded values to rounded values, according to some aspects. The unrounded values may be 34-bit unrounded values produced by the accumulator 520. The tail block 414 may include rounders 906 configured to convert unrounded values to rounded values. In an example, the unrounded values are floating point numbers in the 34-bit unrounded format that is supported internally by the PCU but that may not be externally supported. The rounded values may be FP32 values or BF16 values. The FP32 and BF16 formats are likely to be externally supported because they are well-known and standardized formats that are supported by a wide variety of hardware produced by various manufacturers. It may be a best practice to use a well-known and standardized number format for all values exiting a PCU.

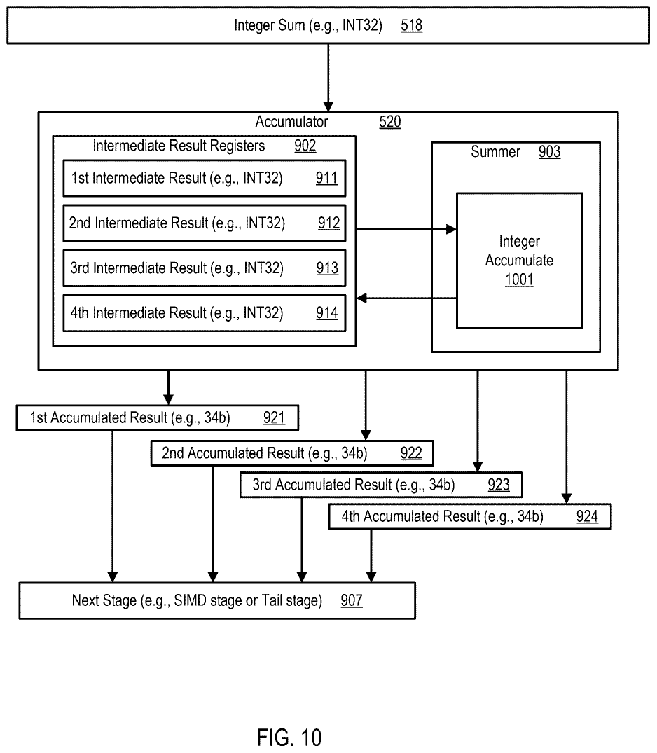

FIG. 10 is an illustration of an example of the circuitry illustrated in FIG. 5 configured to produce accumulated results by accumulating integer sums, according to some aspects. As shown in FIGS. 5 and 8, the adder may produce integer sums 518. The accumulator 520 may have intermediate result registers 902 and an integer accumulator 1001. The illustrated example has four intermediate result registers storing a first intermediate result 911, a second intermediate result 912, a third intermediate result 913, and a fourth intermediate result 914. The integer accumulator 1001 can receive an integer sum 518 and one of the intermediate results and can add the values in one clock cycle, thereby accumulating the integer sum into the intermediate result. The intermediate result (now including the integer sum) may then be stored in the register it was obtained from. The accumulator may cycle through the intermediate result registers. The illustrated accumulator may therefore receive a first, second, third, etc. integer sum and may cycle through the intermediate result registers by accumulating the first, fifth, ninth, etc. integer sums into the first intermediate result, by accumulating the second, sixth, tenth, etc. integer sums into the second intermediate result, by accumulating the third, seventh, eleventh, etc. integer sums into the third intermediate result, and by accumulating the fourth, eighth, twelfth, etc. integer sums into the fourth intermediate result. The intermediate results may be read out of the accumulator as accumulated results. In an example, two large vectors are processed. When the last operands of the vectors have been processed, the first intermediate result 911 is read out as the first accumulated result 921, the second intermediate result 912 is read out as the second accumulated result 922, the third intermediate result 913 is read out as the third accumulated result 923, and the fourth intermediate result 914 is read out as the fourth accumulated result 924. The vector dot product of the two large vectors may be the first accumulated result 921 plus the second accumulated result 922 plus the third accumulated result 923 plus the fourth accumulated result 924. The accumulated results may be passed to the next stage 907, which may be another SIMD stage or a tail stage.

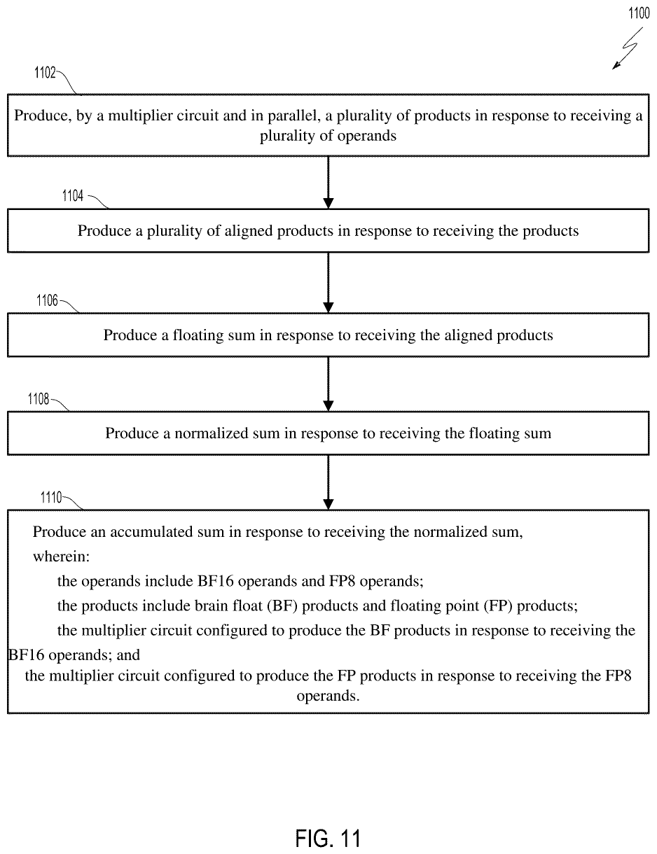

FIG. 11 is a high-level flow diagram illustrating an example of a method 1100 for multi-precision dot product determination, according to some aspects. The method 1100 may be implemented by the circuitry illustrated in FIGS. 4-10. At block 1102 a multiplier circuit may produce, in parallel, a plurality of products in response to receiving a plurality of operands. At block 1104, a plurality of aligned products may be produced in response to receiving the products. At block 1106, a floating sum may be produced in response to receiving the aligned products. At block 1108, a normalized sum may be produced in response to receiving the floating sum. At block 1110 an accumulated sum may be produced in response to receiving the normalized sum, wherein the operands include BF16 operands and FP8 operands, the products include brain float (BF) products and floating point (FP) products, the multiplier circuit configured to produce the BF products in response to receiving the BF16 operands, and the multiplier circuit configured to produce the FP products in response to receiving the FP8 operands.

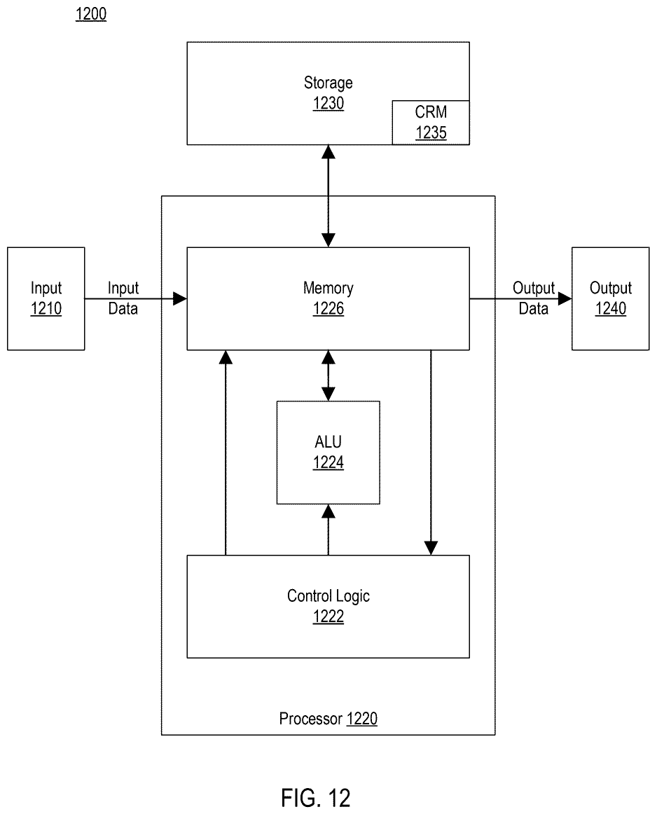

FIG. 12 illustrates an example of a computer 1200, including an input device 1210, a processor 1220, a storage device 1230, and an output device 1240, according to some aspects. Host 101, shown in FIG. 1, may be a computer such as computer 1200. Although the example computer 1200 is drawn with a single processor, other implementations may have multiple processors. Input device 1210 may comprise a mouse, a keyboard, a sensor, an input port (for example, a universal serial bus (USB) port), and any other input device known in the art. Output device 1240 may comprise a monitor, printer, and any other output device known in the art. Furthermore, part or all of input device 1210 and output device 1240 may be combined in a network interface. Input device 1210 is coupled with processor 1220 to provide input data, which an implementation may store in memory 1226. Processor 1220 is coupled with output device 1240 to provide output data from memory 1226 to output device 1240. Processor 1220 further includes control logic 1222, operable to control the memory 1226 and arithmetic and logic unit (ALU) 1224, and to receive program and configuration data from memory 1226. Control logic 1222 further controls exchange of data between memory 1226 and storage device 1230. Memory 1226 typically comprises memory with fast access, such as static random-access memory (SRAM), whereas storage device 1230 typically comprises memory with slow access, such as dynamic random-access memory (DRAM), flash memory, magnetic disks, optical disks, and any other memory type known in the art. At least a part of the memory in storage device 1230 includes a non-transitory computer-readable medium (CRM 1235), such as used for storing computer programs.

Although the operations of the method(s) herein are shown and described in a particular order, the order of the operations of each method may be altered so that certain operations may be performed in an inverse order or so that certain operations may be performed, at least in part, concurrently with other operations. Instructions or sub-operations of distinct operations may be implemented in an intermittent and/or alternating manner.

It may also be noted that at least some of the operations for the methods described herein may be implemented using software instructions stored on a computer usable storage medium for execution by a computer. For example, a computer program product may include a computer usable storage medium to store a computer readable program.

The computer-usable or computer-readable storage medium may be an electronic, magnetic, optical, electromagnetic, infrared, or semiconductor system (or apparatus or device). Examples of non-transitory computer-usable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Although specific examples have been described and illustrated, the scope of the claimed systems, methods, devices, etc. is not to be limited to the specific forms or arrangements of parts so described and illustrated. The scope may be defined by the claims appended hereto and their equivalents.

What is claimed is:

1. A system comprising:
input wires configured to receive 16-bit operands that include BF16 operands and to receive 8-bit operands that include FP8 operands;
multiplier circuitry configured to produce brain float (BF) products in response to receiving the BF16 operands and to produce floating point (FP) products in response to receiving the FP8 operands;
a product converter configured to produce aligned products in response to receiving the BF products and in response to receiving the FP products;
an adder configured to produce a floating sum in response to receiving the aligned products;
a floating sum converter configured to produce a normalized sum in response to receiving the floating sum; and
an accumulator configured to produce an accumulated sum in response to receiving the normalized sum,
wherein sixteen of the input wires are configured to receive one of the 16-bit operands and to receive two of the 8-bit operands.

2. The system of claim 1, wherein the FP8 operands are converted to BF16 before multiplication by the multiplier circuitry.

3. The system of claim 1, wherein:
the 8-bit operands include INT8 operands;
the multiplier circuitry is further configured to produce integer products in response to receiving the INT8 operands;
the adder is further configured to produce an integer sum in response to receiving the integer products; and
the accumulator is further configured to produce the accumulated sum in response to receiving the integer sum.

4. The system of claim 3, wherein:
the multiplier circuitry, the product converter, the adder, and the floating sum converter are configured to produce results each clock cycle.

5. The system of claim 3, wherein:
the accumulator is configured to accumulate a plurality of normalized sums and a plurality of integer sums into a plurality of intermediate results;
the accumulator is configured to accumulate the normalized sum and the integer sum into one of the intermediate results; and
summing the intermediate results produces the accumulated sum.

6. The system of claim 3, wherein:
the multiplier circuitry includes eight multipliers that are each configured to produce one of the FP products in response to receiving two of the FP8 operands, and to produce one of the integer products in response to receiving two of the INT8 operands; and
four of the eight multipliers are each further configured to produce one of the BF products in response to receiving two of the BF16 operands.

7. The system of claim 1, wherein the aligned products have a two's complement 33-bit mantissa.

8. The system of claim 1, wherein the floating sum has a mantissa that is sign-magnitude.

9. The system of claim 1, wherein the floating sum has a 33-bit sign-magnitude mantissa and the normalized sum has a 25-bit sign-magnitude mantissa.

10. The system of claim 1, wherein the normalized sum has a 25-bit mantissa, an 8-bit exponent, and a 1-bit sign.

11. The system of claim 1, wherein:
an intermediate format has a 25-bit mantissa, an 8-bit exponent, and a 1-bit sign;
the floating sum converter is configured to produce a plurality of normalized sums having the intermediate format; and
the accumulator is configured to accumulate the normalized sums into a plurality of intermediate results having the intermediate format.

12. The system of claim 11, further including:
an intra stage register block configured to store the accumulated sum as an unrounded value in a pattern compute unit (PCU) internal format; and
a tail configured to convert the unrounded value stored in the intra stage register block to a rounded value in an externally supported format,
wherein the tail is configured to store the rounded value in a PCU output register block.

13. A method comprising:
producing, by a multiplier circuit and in parallel, a plurality of products in response to receiving a plurality of operands;
producing a plurality of aligned products in response to receiving the products;
producing a floating sum in response to receiving the aligned products;
producing a normalized sum in response to receiving the floating sum; and
producing an accumulated sum in response to receiving the normalized sum,
wherein:
the operands include BF16 operands and FP8 operands;
the products include brain float (BF) products and floating point (FP) products;
the multiplier circuit configured to produce the BF products in response to receiving the BF16 operands; and
the multiplier circuit configured to produce the FP products in response to receiving the FP8 operands.

14. The method of claim 13, wherein at least one of the FP8 operands is converted to BF16 before multiplication by the multiplier circuit.

15. The method of claim 13, further including:
producing, by the multiplier circuit, a plurality of integer products in response to receiving a plurality of INT8 operands;
producing an integer sum in response to receiving the integer products,
wherein:
an adder is configured to produce the floating sum and to produce the integer sum; and
an accumulator is configured to produce the accumulated sum in response to receiving the normalized sum and to produce the accumulated sum in response to receiving the integer sum.

16. The method of claim 15, wherein:
a product converter is configured to produce the aligned products;
the multiplier circuit, the product converter, and the adder, are configured to produce results in a single clock cycle; and
the accumulator is configured to require a plurality of clock cycles to add the floating sum to an intermediate result stored in a register of the accumulator.

17. The method of claim 15, wherein:
the accumulator is configured to accumulate a plurality of normalized sums and a plurality of integer sums into a plurality of intermediate results;
the accumulator is configured to accumulate the normalized sum and the integer sum into one of the intermediate results; and
summing the intermediate results produces the accumulated sum.

18. The method of claim 15, wherein:
the multiplier circuit includes eight multipliers that are each configured to produce one of the FP products in response to receiving two of the FP8 operands, and to produce one of the integer products in response to receiving two of the INT8 operands; and
four of the eight multipliers are each configured to produce one of the BF products in response to receiving two of the BF16 operands.

19. A system comprising:
input wires configured to receive a plurality of operands that include BF16 operands and FP8 operands;
a multiplication means for producing a plurality of products in response to receiving the operands;
an alignment means for producing a plurality of aligned products in response to receiving the products;
a summation means for producing a floating sum in response to receiving the aligned products;
a conversion means for producing a normalized sum in response to receiving the floating sum;
an accumulation means for producing an accumulated sum in response to receiving the normalized sum,
wherein:
the multiplication means for producing the products in response to receiving the operands is configured to produce the products in parallel; and
the multiplication means for producing the products in response to receiving the operands is configured to produce brain float (BF) products in response to receiving the BF16 operands and to produce floating point (FP) products in response to receiving the FP8 operands.

20. The system of claim 19, wherein:
the plurality of operands further include INT8 operands;
the multiplication means is configured to produce integer products in response to receiving the INT8 operands;
the summation means is configured to produce an integer sum in response to receiving the integer products; and
the accumulation means is configured to produce the accumulated sum in response to receiving the integer sum.
